(19) United States
(12) Patent Application Publication
(10) Pub. No.: US 2020/0077358 A1
(43) Pub. Date: Mar. 5, 2020

(54) IDLE MODE MOBILITY IN NEW RADIO BASED NON-TERRESTRIAL NETWORKS

(71) Applicant: NOKIA TECHNOLOGIES OY, Espoo (FI)

(72) Inventors: Istvan KOVACS, Aalborg (DK); Jeroen WIGARD, Klarup (DK); Nitin MANGALVEDHE, Hoffman Estates, IL (US); Benedek SCHULTZ, Budapest (HU)

(21) Appl. No.: 16/119,503

(22) Filed: Aug. 31, 2018

(51) Int. Cl. H04W 64/00; H04W 36/32; H04W 68/06; H04W 4/021; H04W 8/18; H04W 76/27; H04W 28/02

(52) U.S. Cl. CPC H04W 64/006; H04W 36/32; H04W 68/06; H04W 28/0268; H04W 8/18; H04W 76/27; H04W 4/022

(57) ABSTRACT

Systems, methods, apparatuses, and computer program products for mobility management in NR based non-terrestrial networks are provided. One method includes signaling geographical definitions of Geo-Areas (GAs) and/or an update to GA map to at least one user equipment (UE) in a network, and receiving a tracking area update (TAU) and/or radio access network (RAN)-based notification area update (RNAU) when the at least one UE detects a change in the at least one UE's GA location. The method may also include registering the change in the at least one UE's GA location, and configuring at least one of radio access network (RAN)-based notification area (RNA) or tracking area (TA) based on the registered change in the at least one UE's GA location.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to mobility management in NR based non-terrestrial networks.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G is mostly built on a new radio (NR), but the 5G (or NG) network can also build on E-UTRA radio. It is estimated that NR will provide bitrates on the order of 10-20 Gbit/s or higher, and will support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in E-UTRAN or eNB in LTE) may be named gNB when built on NR radio and may be named NG-eNB when built on E-UTRA radio.

### SUMMARY

One embodiment is directed to an apparatus that may include at least one processor and at least one memory comprising computer program code. The at least one memory and computer program code may beconfigured, with the at least one processor, to cause the apparatus at least to signal, to at least one user equipment, at least one of geographical definitions of Geo-Areas (GAs) or updates to a Geo-Areas (GAs) map, and to receive, from the at least one user equipment, at least one of a tracking area update (TAU) or radio access network (RAN)-based notification area update (RNAU) when the at least one user equipment detects a change in the at least one user equipment's Geo-Area (GA) location. The Geo-Area (GA) location of the at least one user equipment is a location of the at least one user equipment relative to the signaled Geo-Areas (GAs). The at least one memory and computer program code may also be configured, with the at least one processor, to cause the apparatus at least to register the change in the at least one user equipment's Geo-Area (GA) location, and to configure, for the at least one user equipment that detected the change in its Geo-Area (GA) location, at least one of a new radio access network (RAN)-based notification area (RNA) or tracking area (TA) based on the registered change in the at least one user equipment's Geo-Area (GA) location.

Another embodiment is directed to a method that may include signaling, to at least one user equipment, at least one of geographical definitions of Geo-Areas (GAs) or updates to a Geo-Areas (GAs) map, and receiving, from the at least one user equipment, at least one of a tracking area update (TAU) or radio access network (RAN)-based notification area update (RNAU) when the at least one user equipment detects a change in the at least one user equipment's Geo-Area (GA) location. The Geo-Area (GA) location of the at least one user equipment is a location of the at least one user equipment relative to the signaled Geo-Areas (GAs). The method may also include registering the change in the at least one user equipment's Geo-Area (GA) location, and configuring, for the at least one user equipment that detected the change in its Geo-Area (GA) location, at least one of a new radio access network (RAN)-based notification area (RNA) or tracking area (TA) based on the registered change in the at least one user equipment's Geo-Area (GA) location.

In an embodiment, the method may also include dynamically configuring Geo-Areas (GAs) such that different Geo-Areas (GAs) are potentially provided to different user equipment depending on at least one of movements of the user equipment, network traffic, service level agreement, or quality of service agreement.

According to an embodiment, the method may also include signaling the geographical definitions of Geo-Areas (GAs) or updates to the Geo-Areas (GAs) map to the at least one user equipment via broadcast or multicast.

In an embodiment, the method may also include pre-programming the at least one user equipment with default geographical definitions of Geo-Areas (GAs). According to an embodiment, the method may also include dynamically mapping at least one tracking area (TA) or registration area (RA) to one of the Geo-Areas (GAs).

According to an embodiment, the method may also include configuring the at least one user equipment to use the geographical definitions of Geo-Areas (GAs) and the user equipment's own location to determine when to send at least one of the tracking area update (TAU) or the radio access network (RAN)-based notification area update (RNAU).

Another embodiment is directed to an apparatus that may include at least one processor and at least one memory comprising computer program code. The at least one memory and computer program code may be configured, with the at least one processor, to cause the apparatus at least to receive geographical definitions of Geo-Areas (GAs) from a network, and to transmit, to the network, at least one of a tracking area update (TAU) or radio access network (RAN)-based notification area update (RNAU) when the apparatus detects a change in the Geo-Area (GA) location of the apparatus.

In an embodiment, the at least one memory and computer program code may be further configured, with the at least one processor, to cause the apparatus at least to receive the geographical definitions of Geo-Areas (GAs) from the network via broadcast or multicast.

According to an embodiment, the apparatus may be pre-configured with default geographical definitions of Geo-Areas (GAs). In an embodiment, the at least one memory and computer program code may be further configured, with the at least one processor, to cause the apparatus at least to use the geographical definitions of Geo-Areas (GAs) and the location of the apparatus to determine when to transmit at least one of the tracking area update (TAU) or the radio access network (RAN)-based notification area update (RNAU). According to an embodiment, the apparatus may include a user equipment.

Another embodiment is directed to an apparatus that may include at least one processor and at least one memory comprising computer program code. The at least one memory and computer program code may be configured, with the at least one processor, to cause the apparatus at least to continuously update information comprising a list including at least one of tracking areas (TAs) and registration areas (RAs) and corresponding cell identifiers covering each Geo-Area (GA) in a network, and to periodically signal the information to at least one user equipment.

Another embodiment is directed to a method that may include continuously updating information comprising a list including at least one of tracking areas (TAs) and registration areas (RAs) and corresponding cell identifiers covering each Geo-Area (GA) in a network, and periodically signaling the information to at least one user equipment.

In an embodiment, the information may be specific to a larger geographical region on earth, so not all base stations covering the earth have to broadcast the same and complete set of information. According to one embodiment, the method may also include dynamically updating the list of tracking areas (TAs) and registration areas (RAs) broadcasted in a given geographical region based on movement of base stations and their beams.

Another embodiment is directed to an apparatus that may include at least one processor and at least one memory comprising computer program code. The at least one memory and computer program code may be configured, with the at least one processor, to cause the apparatus at least to periodically receive information comprising a list including at least one of tracking areas (TAs) and registration areas (RAs) and corresponding cell identifiers covering each Geo-Area (GA) in a network, and to transmit, to the network, at least one of a tracking area update (TAU) or radio access network (RAN)-based notification area update (RNAU) when the apparatus detects a change in the Geo-Area (GA) location of the apparatus.

In an embodiment, the information may be specific to a larger geographical region on earth, so not all base stations covering the earth have to broadcast the same and complete set of information.

### BRIEF DESCRIPTION OF THE DRAWINGS:

For proper understanding of example embodiments, reference should be made to the accompanying drawings, wherein:

FIG. 1 illustrates an example system configuration of Geo-Areas and mapping between TA/RA and GA, according to an embodiment;

FIG. 2a illustrates an example flow diagram of a method, according to one embodiment;

FIG. 2b illustrates an example flow diagram of a method, according to one embodiment;

FIG. 3a illustrates an example flow diagram of a method, according to one embodiment;

FIG. 3b illustrates an example flow diagram of a method, according to one embodiment;

FIG. 4a illustrates an example block diagram of an apparatus, according to one embodiment; and

FIG. 4b illustrates an example block diagram of an apparatus, according to another embodiment.

### DETAILED DESCRIPTION:

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for mobility management in NR based non-terrestrial networks, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

Certain embodiments relate to non-terrestrial networks (NTN) and possible areas of impact on NR associated to mobility management. Table 1 below summarizes these potential areas of impact on NR associated to mobility management for different types of NTN, which are to be studied in RAN2/RAN3. See 3GPP TR 38.811.

TABLE 1

| NTN | | | |
|---|---|---|---|
| Deployment | | | |
| scenarios | GEO | Non GEO | HAPS |
| Cell | Earth fixed: | Motion over earth | Motion over earth |
| pattern | same as in | or earth fixed | (e.g. rotating) & |
| | cellular | | Possibly UE |
| | | | altitude dependent |
| Tracking | Tracking area | For further study | Same as for GEO |
| area | congruent | | and cellular |
| | with cell | | networks |
| | pattern: same | | |
| | as in cellular | | |
| Potential | Mobility | Tracking area | Case 1: tracking |
| areas of | management | to be defined | area corresponds |
| impact | procedures | to minimise | to |
| on NR | (Paging, hand- | MM procedure | HAPS coverage: |
| specifications | over, location | signalling | no impact |
| | update): | Mobility | Case 2: Tracking |
| | Potential | management | area smaller than |
| | extension of | procedures | HAPS total |
| | some timers | (Paging, | coverage, same |
| | | hand-over, | impact as for Non |
| | | location update) | GEO are expected |
| | | to be adapted | |
| | | depending on | |
| | | tracking area | |
| | | design Handling | |
| | | of network | |
| | | identities to be | |
| | | adapted | |

The handover and paging aspects identified as having impact on NR are summarized in 3GPP RP-180658. In NR operating terrestrially, a UE camps on a cell that may be uniquely identified by the RAN from which the UE is receiving the radio signals from. A collection of cells is referred to as a Tracking Area (TA) and a collection of Tracking Areas is referred to as a Registration Area (RA). A cell may belong to both a Tracking Area and a Registration Area.

The 5G NR specifications provide two levels of paging/tracking mechanisms, depending on the RRC state of the UE. See 3GPP TR 38.300. In RRC_IDLE state, the TA can cover one or multiple cells, and be contained within the CN registration area. A TA identifier (TAI) is generated for each TA. One or a list of TAIs are signaled to the UEs when the UEs attach to the network. A Tracking Area Update (TAU) notification is sent by the UEs to notify the network (e.g., AMF) of its current location by sending a TAU message (TAU Request message) every time it detects that is had moved to a TA not included in its currently stored TAI list. A periodical TAU notification is sent by the UEs to the network (e.g., AMF), even if no changes in the TA has been detected, in order to indicate their presence in the network.

A UE in a RRC connected mode (RRC_CONNECTED) and (CM)-IDLE state may perform a Registration Area update when it moves out of a Tracking Area. An access and mobility function (AMF) only needs to be aware of the UE location to the granularity of the Registration Area when a UE is in the CM-IDLE state. If a packet arrives from the internet destined for the UE that is in CM-IDLE state, the AMF attempts to page the UE on all cells belonging to the Registration Area to notify of the arrival of packets destined for it. The RANs that receive the page from the AMF may then transmit a page in the corresponding cells in order to reach the UE, which may be anywhere in the Registration Area. See 3GPP TR 38.811.

In a non-GEO satellite access network, a UE generally camps on a beam of a satellite but, as beams move, the UE may end up camping on different beams and different satellites over time, although the UE may not have actually moved. Unlike the terrestrial framework where a cell on the ground is tied to radio communication with a RAN, in a non-GEO satellite access network, the satellite beams are moving. In this case, there is no correspondence between cells on the ground and satellite beams. The same area on the ground may be covered by different satellites and different beams over time.

Furthermore, satellite beams can be large so that a single beam can encompass more than one area on the ground. Accordingly, for the initial registration, the satellite based radio access network will not be able to provide the TA information to AMF, based on which beam and which satellite the registration request was received from. Since non-GEO beams are moving, there may not be a one-to-one correspondence between moving beams and fixed TAs or RAs. For example, when the TA and RA are defined as geographical area(s) fixed on the ground, the correspondence may be difficult to determine However, this information may be necessary for a UE to determine if it needs to perform a registration area update with AMF in NR.

The satellite cells (footprints, spot beams) and potential 5G NR beams from low earth orbit (LEO)/medium earth orbit (MEO) satellites move quite fast over a given geographical area. Thus, UEs would be triggered to report registration area updates quite often, even if the UEs do not move and/or have data to transmit. In view of the above, certain embodiments provide solutions for how to avoid frequent registration area updates from UEs when they detect (fast) moving beams/cells, such as from LEO/MEO satellites. In addition, example embodiments are able to maintain most or all of the TA and paging mechanisms defined in 5G NR.

According to certain embodiments, tracking areas may be defined as fixed geographical areas on the ground although LEO/MEO satellite beams move over it since these tracking areas are also used for a number of location based decisions, such as authorization, billing, legal interception, etc., in addition to paging. It is noted that as used herein, in some embodiments, a satellite may include or may refer to a base station, eNB, gNB, radio cell(s), radio transmitter(s), or the like.

In RRC_INACTIVE state, the RAN-based Notification Area (RNA) can cover a single or multiple cells, and be contained within the CN registration area. A RAN-based notification area update (RNAU) is periodically sent by the UE and is also sent when the cell reselection procedure of the UE selects a cell that does not belong to the configured RNA. The above-described mechanisms may need the definition/configuration of list of cells or list of RAN areas. For example, a UE can be provided an explicit list of cells (one or more) that constitute the RNA. Alternatively or additionally, a UE can be provided (at least one) RAN area ID, where a RAN area is a subset of a CN TA or equal to a CN TA. A RAN area is specified by one RAN area ID, which includes a TAI and optionally a RAN area Code. A cell may broadcast a RAN area ID in the system information.

NG RAN may provide different RNA definitions to different UEs but not mix different definitions to the same UE at the same time. A UE may support all RNA configuration options listed above.

In LTE and 5G, the concept of “zones” (geographical areas) has been introduced to help the radio resource allocation for direct and side-links. Inherently, the TA/RA definitions in 3GPP do not actually refer to a geographical area, but rather to a set of cells which are logically defining a TA or RA. In NTN, a more direct link between TA/RA and actual geographical areas covered by the satellite spot-beams has been proposed. See 3GPP TR 38.811.

Conventionally, the mobile terminal geographical location information (GNSS location) is explicitly used in the management of the satellite beams and beam handovers. As a result, in previous approaches, the mobile terminal (e.g., UE) is expected to provide this location information to the satellite radio network.

However, certain embodiments described herein provide a mechanism in which the TA and RA definitions, which are logically linked/mapped to geographical areas on Earth covered by one or more satellite spot beams, are explicitly signaled to UE(s). Further, in example embodiments, the UE global navigation satellite system (GNSS) location information is not used in RAN/AMF.

In one example embodiment, the geographical definitions of the Geographical-Areas (GAs) may be explicitly signaled to the UE(s), for example, via broadcast or multicast. According to an embodiment, a ‘base’ or default version of the geographical definitions of the GA(s) may be pre-programmed or pre-configured in the UE(s), e.g., similar to a pre-loaded map grid in a GNSS based navigation device.

It is noted that a GA is not a replacement for the 3GPP TA/RA. Rather, in an embodiment, one or more TA/RAs may be mapped to a GA in a dynamic fashion. Also, in one example, the UE(s) may be configured so as not to send TAU/RNAU in traditional mode, but instead use the GA definition (i.e., the GA definition explicitly signalled to the UE or pre-programmed in the UE) and the UE's own location.

According to one embodiment, the mapping of TA/RAs to GAs may only be known in the RAN/AMF and the UE does not need to be informed about it. In another embodiment, one or more pre-programmed GAs definitions may be provided in the UE(s) and the networks would only signal to the UE(s) which set of the GAs definitions to use. In some embodiments, GAs can be configured both statically (e.g., similar to defining a state or country border in a map) or dynamically (e.g., adapted to location and UE requirements). The dynamic configuration option may provide better fine-tuning to different GAs and potentially different GAs can be provided to different UEs depending on their movements, traffic, etc.

The full GA definition (e.g., coordinates of the vertices) may include a very large data set and therefore likely cannot be broadcast; in this case, a ‘base’ or default map may be provided via broadcast or multicast to the NTN UE(s). The details or changes in the GA may be signaled via the physical downlink shared channel (PDSCH) as part of the on-demand system information. It should be noted that the GA definition is not the same as the information on the location of the beams and/or ephemeris of the satellites.

In one example embodiment, the NTN UE(s) may send tracking area updates when they detect a change in their GA location and may have some means of localization, e.g. GNSS, and interface between localization implementation and the 3GPP UE implementation. As such, according to an embodiment, the NTN UE(s) do not need to consistently report location information to the network and, therefore, can remain in RRC_IDLE mode thereby conserving battery life. According to certain embodiments, a network node, such as a gNB (RAN/AMF), may register changes in the GA of one or more NTN UE(s) and may configure the RNA and TA accordingly.

According to another embodiment, a network node, such as a gNB (RAN/AMF), may continuously update the list of TA/RAs and corresponding cell identifiers (IDs) covering each GA. In an embodiment, the network node may periodically signal this information (i.e., the list of TA/RAs and corresponding cell IDs covering each GA) to the UE(s) via broadcast or on-demand, for example. In one example, the information may be specific to a larger geographical region on Earth, so not all satellites (covering Earth) have to broadcast the same and complete set of information. According to one embodiment, the list of TA/RAs broadcasted in a given geographical region may be dynamically updated based on the movement of the satellites and their beams (e.g., using the same mechanisms as specified in 3GPP LTE/NR). The NTN UEs may use the RNA/TA information as normal and, if they detect changes, the UE(s) may signal RNAU and TAU as currently specified.

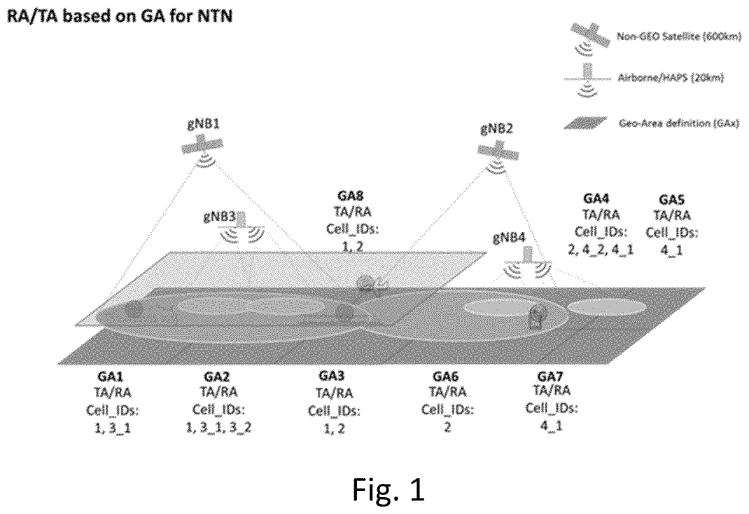

FIG. 1 illustrates an example of a possible configuration of the Geo-Areas (GAs) and the mapping of TA/RA cell IDs to GAs, according to an embodiment. The cell IDs (same as beam IDs in this example, but not the only configuration possible) may be mapped to GAs based on their radio beam foot-prints on Earth. For simplicity, FIG. 1 depicts the gNBs (or base stations) on board the satellites, but example embodiments may also apply to other configurations including, for example gNB, gNB-DU and bent-pine (NR-Uu) deployment options.

Furthermore, FIG. 1 depicts one ‘time snapshot,’ i.e., due to the movement of the gNB3 and gNB4, their corresponding cell IDs would need to be included in or excluded from the mapping of the GAs dynamically (or periodically). In one embodiment, the cell IDs in the TA/RA do not need to be signaled to the UEs because all TAU/RNAU procedures are based on the GA instead.

Certain embodiments provide flexibility in defining GAs areas/shapes, e.g., the GA1 to GA3 are different compared to GA4-GA7 and GA8 and GA5/GA7 are smaller compared to the other GA. Some embodiments also allow for flexibility in the selection of GAs to be signaled to each UE, for example, depending on their location, mobility or satellite subscription type. In the example of FIG. 1, it is depicted that not all UEs would need to use the same GA definitions. For example, a high-speed airplane UE may be using GA8 while terrestrial UEs may be using GA1-7. In this example, the RAN/AMF may include a different set of cell IDs in the GA8 compared to GA1-7 in order to provide the best or optimal TA/RA for the airplane UE.

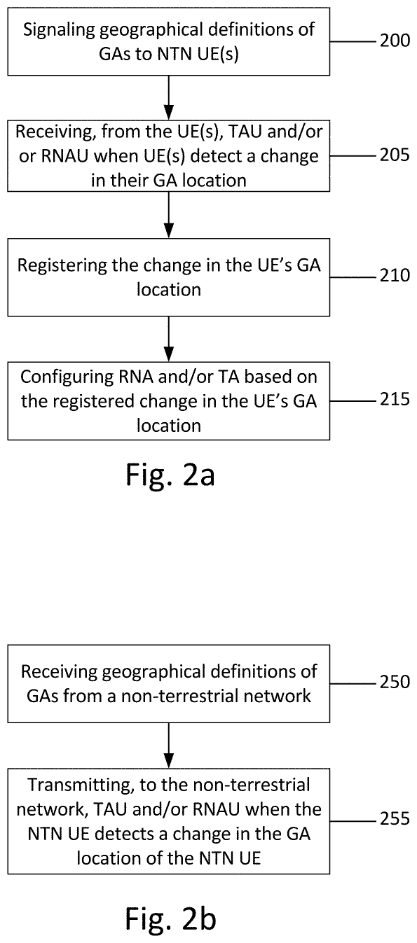

FIG. 2a illustrates an example flow diagram of a method for mobility management in NR based NTN, according to an example embodiment. In certain example embodiments, the flow diagram of FIG. 2a may be performed by a network entity or network node in a 3GPP communication system, such as LTE or 5G NR. In an embodiment, the communication system may be a NR based NTN. For instance, in some example embodiments, the method of FIG. 2a may be performed by a base station, eNB, gNB, or an access node or the like in a 5G or NR system.

In one embodiment, the method of FIG. 2a may include, at 200, signaling geographical definitions of GAs and/or updates relative to a GAs map (e.g., map that has been pre-programmed or downloaded apriority) to one or more UE(s) in a NTN. According to an embodiment, the signaling 200 may include explicitly signaling the geographical definitions of the GAs and/or the updates to the GAs map to the UE(s) via broadcast or multicast. As the full GA definition (e.g., coordinates of the vertices) may be a very large data set that cannot be broadcast, in one example, a ‘base’ map may be provided via broadcast or multicast to the UE(s). In an embodiment, details or changes in the GA may be signaled via PDSCH as part of on-demand system information.

According to an embodiment, the method may also include, at 205, receiving, from the UE(s), a TAU and/or or RNAU when the UE(s) detect a change in the GA location of the UE(s). It is noted that, in one embodiment, the GA location may refer to the location of the UE relative to the GA(s) signaled by the network. As such, a change in the GA location of the UE(s) means that the UE(s) have moved to a different area. According to some embodiments, the method may also include, at 210, registering the change in the UE's GA location and, at 215, configuring RNA and/or TA, for the UE(s) that detected the change in their GA location, based on the registered change in the UE's GA location.

In some embodiments, the method may also include dynamically configuring GAs such that different GAs may potentially be provided to different UEs depending, for example, on the movements of the UEs, network traffic, service level agreement (SLA), and/or QoS agreement. According to an embodiment, the method may further include pre-configuring or pre-programming the UE(s) with default geographical definitions of the GAs.

According to an embodiment, the method may additionally include dynamically mapping TA and/or RA to one of the GAs. In an example embodiment, the method may also include configuring the UE(s) to use the geographical definitions of the GAs and the UE's own location to determine when to send the TAU and/or the RNAU. In other words, according to an embodiment, the UE is configured not to send TAU/RNAU in traditional mode and, therefore, the UE can remain in IDLE mode for a longer period so as to save battery life.

FIG. 2b illustrates an example flow diagram of a method for mobility management in a NR based NTN, according to an example embodiment. In certain example embodiments, the flow diagram of FIG. 2b may be performed by a mobile station, device, user terminal or UE, associated with a communications system or network, such as a 5G or NR system. For example, in one embodiment, the method of FIG. 2b may be performed by a NTN UE.

In an embodiment, the method of FIG. 2b may include, at 250, receiving, from a NTN, geographical definitions of GAs and/or updates to a GAs map. For example, the receiving 250 may include receiving the geographical definitions of GAs and/or updates to the GAs map from a gNB in a NTN. In an embodiment, the receiving 250 may include receiving the geographical defmitions of GAs from the NTN via broadcast or multicast. In some embodiments, the NTN UE may be pre-configured or pre-programmed with default geographical definitions of the GAs.

According to an embodiment, the method may also include, at 255, transmitting, to the NTN, a TAU and/or RNAU when the NTN UE detects a change in the GA location of the NTN UE. In some embodiments, the method may also include using the geographical definitions of the GAs and the location of the NTN UE to determine when to transmit the TAU and/or the RNAU.

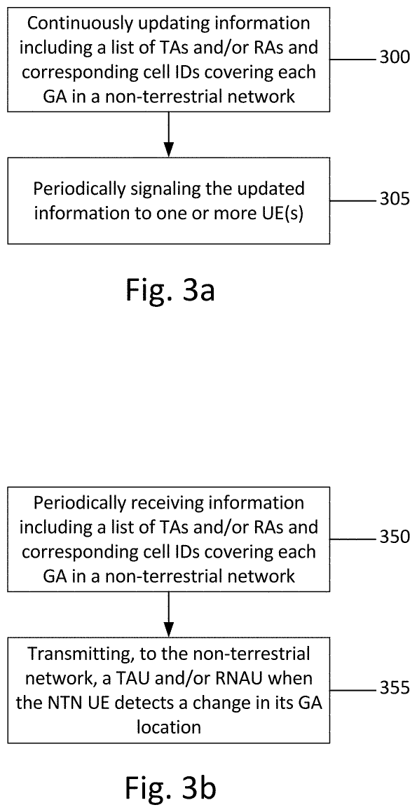

FIG. 3a illustrates an example flow diagram of a method for mobility management in NR based NTN, according to an example embodiment. In certain example embodiments, the flow diagram of FIG. 3a may be performed by a network entity or network node in a 3GPP communication system, such as LTE or 5G NR. In an embodiment, the communication system may be a NR based NTN. For instance, in some example embodiments, the method of FIG. 3a may be performed by a base station, eNB, gNB, or an access node or the like in a 5G or NR system.

In one embodiment, the method of FIG. 3a may include, at 300, continuously updating information including a list of TAs and/or RAs and corresponding cell IDs covering each GA in a non-terrestrial network. The method may then include, at 305, periodically signaling this updated information to one or more UE(s). According to one example, the information may be specific to a larger geographical region on earth, so not all satellites or base stations covering the earth have to broadcast the same and complete set of information. In certain embodiments, the method may include dynamically updating the list of TAs and RAs broadcasted in a given geographical region based on the movement of satellites or base stations and their beams.

FIG. 3b illustrates an example flow diagram of a method for mobility management in a NR based NTN, according to an example embodiment. In certain example embodiments, the flow diagram of FIG. 3b may be performed by a mobile station, device, user terminal or UE, associated with a communications system or network, such as a 5G or NR system. For example, in one embodiment, the method of FIG. 3b may be performed by a NTN UE.

In an embodiment, the method of FIG. 3b may include, at 350, periodically receiving information including a list of TAs and/or RAs and corresponding cell IDs covering each GA in a non-terrestrial network. The method may then include, at 355, transmitting, to the non-terrestrial network, a TAU and/or RNAU when the NTN UE detects a change in its GA location.

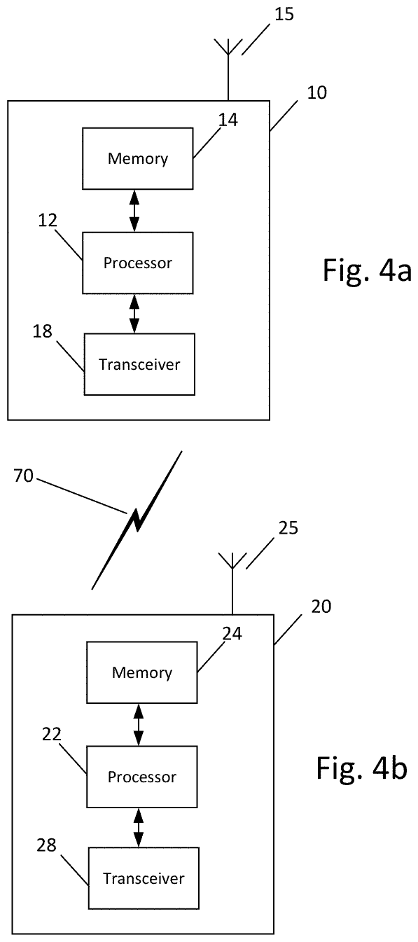

FIG. 4a illustrates an example of an apparatus 10 according to an embodiment. In an embodiment, apparatus 10 may be a node, host, or server in a communications network or serving such a network. For example, apparatus 10 may be a satellite, base station, a Node B, an evolved Node B (eNB), 5G Node B or access point, next generation Node B (NG-NB or gNB), WLAN access point, mobility management entity (MME), and/or subscription server associated with a radio access network, such as a GSM network, LTE network, 5G or NR.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 4a.

As illustrated in the example of FIG. 4a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 4a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like. According to certain embodiments, apparatus 10 may be controlled by memory 14 and processor 12 to perform the functions associated with any of the embodiments described herein, such as the flow or signaling diagrams illustrated in FIG. 2a or 3a. In some embodiments, apparatus 10 may be configured to perform a procedure for mobility management in a NR based NTN. As such, in one embodiment, apparatus 10 may be a gNB in a NTN.

For instance, in one embodiment, apparatus 10 may be controlled by memory 14 and processor 12 to signal geographical defmitions of GAs and/or updates to GAs map to one or more UE(s) in a NTN. According to an embodiment, apparatus 10 may be controlled by memory 14 and processor 12 to explicitly signal the geographical defmitions of the GAs and/or the updates to the GAs map to the UE(s) via broadcast or multicast. In one example, since the full GA definition (e.g., coordinates of the vertices) may be a very large data set that cannot be broadcast, a ‘base’ map may be provided via broadcast or multicast to the UE(s). In an embodiment, apparatus 10 may be controlled by memory 14 and processor 12 to signal details or changes in the GA via PDSCH as part of on-demand system information.

According to an embodiment, apparatus 10 may be controlled by memory 14 and processor 12 to receive, from the UE(s), a TAU and/or or RNAU when the UE(s) detect a change in the GA location of the UE(s). For example, in one embodiment, the UE(s) may send TAU and/or or RNAU to apparatus 10 only when the UE(s) detect a change in their GA location. According to some embodiments, apparatus 10 may be controlled by memory 14 and processor 12 to register the change in the UE's GA location, and to configure RNA and/or TA based on the registered change in the UE's GA location.

In some embodiments, apparatus 10 may be controlled by memory 14 and processor 12 to dynamically configure GAs such that different GAs may potentially be provided to different UEs depending, for example, on the movements of the UEs and/or network traffic. According to an embodiment, apparatus 10 may be controlled by memory 14 and processor 12 to pre-configure or pre-program the UE(s) with default geographical defmitions of the GAs.

According to an embodiment, apparatus 10 may be further controlled by memory 14 and processor 12 to dynamically map TA and/or RA to one of the GAs. In an example embodiment, apparatus 10 may be controlled by memory 14 and processor 12 to configure the UE(s) to use the geographical defmitions of the GAs and the UE's own location to determine when to send the TAU and/or the RNAU. In other words, according to an embodiment, the UE is configured not to send TAU/RNAU in traditional mode and, therefore, the UE can remain in IDLE mode for a longer period and save battery life.

In another embodiment, apparatus 10 may be controlled by memory 14 and processor 12 to continuously update information including a list of TAs and/or RAs and corresponding cell IDs covering each GA in a non-terrestrial network. According to an embodiment, apparatus 10 may then be controlled by memory 14 and processor 12 to periodically signal this information to one or more UE(s). According to one example, the information may be specific to a larger geographical region on earth, so not all satellites or base stations covering the earth have to broadcast the same and complete set of information. In certain embodiments, apparatus 10 may be controlled by memory 14 and processor 12 to dynamically update the list of TAs and RAs broadcasted in a given geographical region based on the movement of satellites or base stations and their beams.

FIG. 4b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, UE may alternatively be referred to as, for example, a mobile station, mobile equipment, mobile unit, mobile device, user device, subscriber station, wireless terminal, tablet, smart phone, IoT device or NB-IoT device, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4b.

As illustrated in the example of FIG. 4b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 10 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with example embodiments described herein. For example, in some embodiments, apparatus 20 may be configured to perform one or more of the processes depicted in any of the flow charts or signaling diagrams described herein, such as the flow diagrams illustrated in FIG. 2b or 3b. For example, in certain embodiments, apparatus 20 may be configured to perform a procedure for mobility management in a NR based NTN.

According to some embodiments, apparatus 20 may be controlled by memory 24 and processor 22 to receive geographical definitions of GAs from a non-terrestrial network. For example, apparatus 20 may be controlled by memory 24 and processor 22 to receive the geographical definitions of GAs from a gNB in a non-terrestrial network. In an embodiment, apparatus 20 may be controlled by memory 24 and processor 22 to receive the geographical definitions of GAs from the non-terrestrial network via broadcast or multicast. In some embodiments, apparatus 20 may be pre-configured or pre-programmed with default geographical definitions of the GAs.

According to an embodiment, apparatus 20 may be controlled by memory 24 and processor 22 to transmit, to the non-terrestrial network, a TAU and/or RNAU when the NTN UE detects a change in the GA location of the NTN UE. In some embodiments, apparatus 20 may be controlled by memory 24 and processor 22 to use the geographical definitions of the GAs and the location of the apparatus 20 to determine when to transmit the TAU and/or the RNAU.

In another embodiment, apparatus 20 may be controlled by memory 24 and processor 22 to periodically receive information including a list of TAs and/or RAs and corresponding cell IDs covering each GA in a non-terrestrial network. According to an embodiment, apparatus 20 may then be controlled by memory 24 and processor 22 to transmit, to the non-terrestrial network, a TAU and/or RNAU when the NTN UE detects a change in its GA location.

Therefore, certain example embodiments provide several technical improvements, enhancements, and/or advantages. For example, certain embodiments provide improvements to mobility management in NR based non-terrestrial networks.

In an embodiment, a gNB (RAN/AMF) does not need to collect or use the GNSS location of all NTN UEs. This avoids unnecessary power consumption on the UE side (e.g., RRC signaling, etc.). Registration area mechanisms can make use of the GAs in an embodiment without the need to know the exact GNSS location of the UEs.

According to an embodiment, the NTN UE GNSS location is only used by the UE itself and the accuracy only needs to be sufficient to detect changes in GA. Instead of GNSS localization, any other localization can be used depending on the use case. This allows UE(s) in IDLE or INACTIVE mode to perform TAU/RNAU using the GA definition, without the need to establish RRC connection and signal their GNSS location to RAN/AMF. The cell ID to GA mapping does not need to be signaled to the UEs.

In another embodiment, the NTN UE GNSS location is not needed but the cell ID to GA mapping may need to be signaled to the UEs.

According to certain embodiments, the GAs do not need to be defined as a regular grid over the entire Earth (or satellite coverage area). The GA size and shape can be adapted (statically defined, or dynamically updated) depending on the are covered, e.g., land vs. sea, built-up vs. remote, etc. GAs can have any shape that allows a suitable tiling pattern (e.g., hexagon, squares) in the area of interest.

Certain embodiments allow for seamless operation of NTN combined with terrestrial networks, e.g., in harbor areas, airports, etc. Terrestrial RAN may re-use the GA-based TAU/RNAU mechanisms proposed in example embodiments.

With standardized inter-satellite communications, the cell ID to GA mapping information can be shared between gNBs, and also between gNBs using different type of satellites, e.g., LEO and HAPS. These can be operated by the same operator or different operators. Example embodiments may be applicable for gNB on satellite, gNB-DU on satellite and radio frequency bent-pine (NR-Uu) deployment options.

As such, example embodiments may improve power efficiency, performance, latency, and/or throughput of networks and network nodes including, for example, access points, base stations/eNBs/gNBs, and mobile devices or UEs. Accordingly, the use of certain example embodiments results in improved functioning of communications networks and their nodes.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and include program instructions to perform particular tasks.

A computer program product may comprise one or more computer-executable components which, when the program is run, are configured to carry out some example embodiments. The one or more computer-executable components may be at least one software code or portions of it. Modifications and configurations required for implementing functionality of an example embodiment may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the example embodiments as discussed above may be practiced with steps in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments. In order to determine the metes and bounds of the example embodiments, therefore, reference should be made to the appended claims.

### PARTIAL LIST OF ABBREVIATIONS

GA Geo(graphical) Area

GEO GEOstationary satellite

HAPS High Altitude Platform

LEO Low Earth Orbit satellite

MEO Medium Earth Orbit satellite

MNO Mobile Network Operator

NGSO Non-GEO stationary Orbit systems/satellites (i.e., LEO, MEO and HAPS)

NTN Non-Terrestrial Networks

RAN Radio Access Networks

RNA RAN-based Notification Area

RNAU RAN-based Notification Area Update

TAU Tracking Area Updates.

1. An apparatus, comprising:
at least one processor; and
at least one memory comprising computer program code,
the at least one memory and computer program code configured, with the at least one processor, to cause the apparatus at least to
signal, to at least one user equipment, at least one of geographical coordinates of Geo-Areas (GAs) or updates to a Geo-Areas (GAs) map;
receive, from the at least one user equipment, at least one of a tracking area update (TAU) or radio access network (RAN)-based notification area update (RNAU) when the at least one user equipment detects a change in the at least one user equipment's Geo-Area (GA) location, wherein the Geo-Area (GA) location of the at least one user equipment is a location of the at least one user equipment relative to the signaled Geo-Areas (GAs);
register the change in the at least one user equipment's Geo-Area (GA) location; and
configure, for the at least one user equipment that detected the change in its Geo-Area (GA) location, at least one of a new radio access network (RAN)-based notification area (RNA) or tracking area (TA) based on the registered change in the at least one user equipment's Geo-Area (GA) location.

2. The apparatus according to claim 1, wherein the at least one memory and computer program code are further configured, with the at least one processor, to cause the apparatus at least to:
dynamically configure Geo-Areas (GAs) such that different Geo-Areas (GAs) are potentially provided to different user equipment depending on at least one of movements of the user equipment, network traffic, service level agreement, or quality of service agreement.

3. The apparatus according to claim 1, wherein the at least one memory and computer program code are further configured, with the at least one processor, to cause the apparatus at least to:
signal the geographical coordinates of Geo-Areas (GAs) or updates to the Geo-Areas (GAs) map to the at least one user equipment via broadcast or multicast.

4. The apparatus according to claim 1, wherein the at least one memory and computer program code are further configured, with the at least one processor, to cause the apparatus at least to:
pre-program the at least one user equipment with default geographical coordinates of Geo-Areas (GAs).

5. The apparatus according to claim 1, wherein the at least one memory and computer program code are further configured, with the at least one processor, to cause the apparatus at least to:
dynamically map at least one tracking area (TA) or registration area (RA) to one of the Geo-Areas (GAs).

6. The apparatus according to claim 1, wherein the at least one memory and computer program code are further configured, with the at least one processor, to cause the apparatus at least to:
configure the at least one user equipment to use the geographical coordinates of Geo-Areas (GAs) and the user equipment's own location to determine when to send at least one of the tracking area update (TAU) or the radio access network (RAN)-based notification area update (RNAU).

7. The apparatus according to claim 1, wherein the apparatus comprises a gNB.

8. A method, comprising:
signaling, to at least one user equipment, at least one of geographical coordinates of Geo-Areas (GAs) or updates to a Geo-Areas (GAs) map;
receiving, from the at least one user equipment, at least one of a tracking area update (TAU) or radio access network (RAN)-based notification area update (RNAU) when the at least one user equipment detects a change in the at least one user equipment's Geo-Area (GA) location, wherein the Geo-Area (GA) location of the at least one user equipment is a location of the at least one user equipment relative to the signaled Geo-Areas (GAs);
registering the change in the at least one user equipment's Geo-Area (GA) location; and
configuring, for the at least one user equipment that detected the change in its Geo-Area (GA) location, at least one of a new radio access network (RAN)-based notification area (RNA) or tracking area (TA) based on the registered change in the at least one user equipment's Geo-Area (GA) location.

9. The method according to claim 8, further comprising:
dynamically configuring Geo-Areas (GAs) such that different Geo-Areas (GAs) are potentially provided to different user equipment depending on at least one of movements of the user equipment, network traffic, service level agreement, or quality of service agreement.

10. The method according to claim 8, further comprising:
signaling the geographical coordinates of Geo-Areas (GAs) or updates to the Geo-Areas (GAs) map to the at least one user equipment via broadcast or multicast.

11. The method according to claim 8, further comprising:
pre-programming the at least one user equipment with default geographical coordinates of Geo-Areas (GAs).

12. The method according to claim 8, further comprising:
dynamically mapping at least one tracking area (TA) or registration area (RA) to one of the Geo-Areas (GAs).

13. The method according to claim 8, further comprising:
configuring the at least one user equipment to use the geographical coordinates of Geo-Areas (GAs) and the user equipment's own location to determine when to send at least one of the tracking area update (TAU) or the radio access network (RAN)-based notification area update (RNAU).

14. An apparatus, comprising:
at least one processor; and
at least one memory comprising computer program code,
the at least one memory and computer program code configured, with the at least one processor, to cause the apparatus at least to
receive geographical defmitions of Geo-Areas (GAs) from a network; and
transmit, to the network, at least one of a tracking area update (TAU) or radio access network (RAN)-based notification area update (RNAU) when the apparatus detects a change in the Geo-Area (GA) location of the apparatus.

15. The apparatus according to claim 14, wherein the at least one memory and computer program code are further configured, with the at least one processor, to cause the apparatus at least to:
receive the geographical defmitions of Geo-Areas (GAs) from the network via broadcast or multicast.

16. The apparatus according to claim 14, wherein the apparatus is pre-configured with default geographical defmitions of Geo-Areas (GAs).

17. The apparatus according to claim 14, wherein the at least one memory and computer program code are further configured, with the at least one processor, to cause the apparatus at least to:
use the geographical defmitions of Geo-Areas (GAs) and the location of the apparatus to determine when to transmit at least one of the tracking area update (TAU) or the radio access network (RAN)-based notification area update (RNAU).

18. The apparatus according to claim 14, wherein the apparatus comprises a user equipment.

19. The apparatus according to claim 1,
wherein the at least one memory and computer program code are configured, with the at least one processor, to cause the apparatus at least to
continuously update information comprising a list including at least one of tracking areas (TAs) and registration areas (RAs) and corresponding cell identifiers covering each Geo-Area (GA) in a network; and
periodically signal the information to the at least one user equipment.

20. A computer readable medium comprising program instructions stored thereon for performing a method according to claim 8.
